(19) United States
(12) Patent Application Publication
(10) Pub. No.: US 2006/0053559 A1
(43) Pub. Date: Mar. 16, 2006

(54) Encapsulated insulating product and method for making same

(76) Inventors: Pierre Vantilt, Tongeren (BE); Philippe Corteil, Stembert (BE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/496,118

(22) PCT Filed: Nov. 19, 2002
(86) PCT No.: PCT/BE02/00174

§ 371 Date: Oct. 7, 2004

(30) Foreign Application Priority Data
Nov. 19, 2001 (BE) 010752

(51) Int. Cl. B32B 3/04

(52) U.S. Cl. 5/690; 156/216; 156/227; 5/952

(57) ABSTRACT

Encapsulated insulation product includes a mattress (1) of fibres and a cladding covering the two principal surfaces (2, 3) and the two lateral surfaces (4, 5) of the mattress, this cladding including a first covering means in the form of a band (6) which covers at least a central part of the first principal surface (2) without extending beyond it and whilst being connected thereto, and a second covering means (7-9) which covers the second principal surface (3) of the mattress, its two lateral surfaces (4, 5) and marginal parts of its first principal surface, the second covering means being connected to the first and second principal surfaces and floating freely along the opposite lateral surfaces (4, 5) of the mattress.

The present invention relates to an encapsulated insulation product, comprising a mattress of fibres which extends longitudinally and comprises first and second opposite principal faces, first and second opposite lateral faces and first and second opposite end faces, and a cladding covering two principal surfaces and two lateral surfaces of the mattress, this cladding comprising a first covering means in the form of a band which covers at least a central part of the first principal surface of the mattress without extending beyond this first surface and being connected thereto, and a second covering means which successively covers the second principal surface of the mattress, its two lateral surfaces and marginal parts of its first principal surface.

Such products which, through their encapsulation, allow manipulation without contact with the core of fibres, a contact which may prove inconvenient and even irritating for the operator, have been known for a long time. Losses of particles of fibres to the outside, with the possible formation of dust, may thus be avoided. Moreover, the external appearance of the product is better finished, even in the coiled state of the fibre core in mattress form.

The patent U.S. Pat. No. 5,240,527 and the Japanese patent applications 51-064584, 52-135383 and 55-164150 can be cited for example. In these patent documents, a second covering band is connected solely to the first principal surface by means of the first covering band. There is no connection on the second covering band either with the second principal surface of the mattress of fibres or with the lateral surfaces. These products therefore have a recognised mechanical weakness through the fact that they are liable to be delaminated, a respective movement between the mattress and the covering bands being difficult to avoid. With a view to attempting to remedy this drawback, it is possible to make provision, at the time of the encapsulation and bonding, for vigorously pressing each constituent of the product against each other. However, in this case, the mattress of fibres is encapsulated in a highly compressed state, which reduces its insulation capability.

An encapsulated insulation product of this type is also known in which a second covering band is also connected to the second principal surface and to at least one lateral surface, preferably to the two lateral surfaces (see WO 97/08401). The problem of the delamination of the composite product is thus largely surmounted. However, the encapsulation is such that the air present in the mattress of mineral fibres can scarcely escape when the mattress is coiled after its manufacture. The result is a difficulty in coiling the product and, for the same volume of roll, it is possible to store a less long length of product.

There are also known systems for the mutual fixing of two covering bands around a mattress of fibres, for example using tabs folded from these bands whilst projecting laterally outside the product, so as to be able to be bonded to each other (see EP-A-0839968 and U.S. Pat. No. 2,028,253). The presence of these tabs presents a major drawback in the application of rolls alongside each other. Manufacture proves more complex and packaging in rolls more complicated.

Insulation products are also known in which the mattress of fibres is packaged in a perforated film so as to improve the discharge of air from the mattress when it is compressed and the return of the mattress to its initial shape when the product is applied on the site to be insulated (see U.S. Pat. No. 5,362,539). These perforations obviously have the effect of weakening the packaging film vis-á-vis mechanical stresses.

The purpose of the present invention is to propose an encapsulated insulation product as indicated at the start, which affords at the same time protection for the operator and the environment, good resistance to delamination and satisfactory suitability for compression, and then an automatic expansion of the mattress of fibres when the compression force disappears. Advantageously, this product must also have a finished and commercially favourable external appearance and be easy to store and apply.

These problems have been resolved according to the invention by an encapsulated product as indicated at the start in which the second covering means is connected to the first and second principal surfaces and floats freely along the opposite lateral surfaces of the mattress. Through the fact that the first covering means in the form of a band is firmly fixed to the first principal surface of the mattress of fibres and the second covering means is firmly fixed to the second principal surface and also to the first principal surface, at its marginal parts, the product has irreproachable mechanical resistance to delamination. Moreover, the floating sides of the covering enable air to escape easily from the product during the compression stage, during its winding in rolls, and enables the product to recover its initial thickness when the rolls are unwound. All this without having to provide openings in the covering, nor microperforations, which weaken the latter.

According to one embodiment of the invention, the second covering means is a band of non-woven material. The covering of the product is thus formed from two covering bands. As a non-woven material appropriate for the second covering band, polypropylene (PP) or polyester (PES) can for example be cited.

According to another embodiment of the invention the second covering means consists of a central strip which covers at least a central part of the second principal surface of the mattress and which is connected thereto, and two lateral strips attached to the central strip on each side thereof, each lateral strip passing in a floating manner along a lateral surface of the mattress, and covering at least a marginal part of the first principal surface of the mattress and at least a marginal part of the second principal surface whilst being connected to these.

The cladding of the product is thus formed from four different pieces, the first covering band, the central strip and the lateral strips, which can thus each be of different natures according to the function attributed to them and the properties expected of them. This also makes it possible to optimise the mechanical strength of the whole, for example by determining the width of double covering on the first and second principal surfaces of the mattress.

According to one advantageous embodiment of the invention, the central strip of the second covering means is a vapour-arresting strip which can cover the whole of the second principal surface of the core. In this way an insulation product is obtained which is particularly appropriate for the insulation of dwelling houses, which prevents penetration of moisture into the mattress of fibres, and therefore the drawbacks associated with such penetration.

The vapour arresters used in insulation products according to the invention are well known to persons skilled in the art. It is possible for example to envisage a sheet of paper, advantageously of the kraft type, which is clad with a coextruded polymer film or a plastic film, possibly metallised, or an aluminium film.

The lateral strips are preferably made from a non-woven material, advantageously very flexible to enable them to buckle when the product is compressed. For example, polypropylene (PP) or polyester (PES) can be envisaged.

The first covering band can be made from a woven or non-woven material. It is possible to envisage for example a non-woven polyester or polyester/viscose or a glass cloth.

Other embodiments of the product according to the invention are indicated in the accompanying claims.

The present invention also concerns a method of manufacturing an encapsulated insulation product according to the invention.

There is provided, according to the invention, such a method comprising a depositing of the first covering means in the form of a band on the first principal surface of the mattress of fibres and its connection thereto, an application of the second covering means to the second principal surface of the mattress of fibres and its connection thereto, a folding of the second covering means along the opposite lateral surface of the mattress and a folding of the second covering means over at least the marginal parts of the first principal surface with connection of the second covering means thereto, so that it floats freely along the opposite lateral surfaces of the mattress.

According to an advantageous embodiment of the method according to the invention, the second covering means consists of a central strip and two lateral strips and the method also comprises, before or during the application of the second covering means to the second principal surface of the mattress, an attachment of the lateral strips to the central strip, on each side thereof.

The connection of the covering means to the first and second surfaces of the mattress and of the covering means between them, as well as the attachment of the lateral strips to the central strip, can be effected by any means known to specialists. Bonding by means of a suitable adhesive is preferably envisaged.

Other embodiments of the method according to the invention are indicated in the accompanying claims.

Other details and particularities of the invention will emerge from the description given below, non-limitingly, with reference to the accompanying drawings.

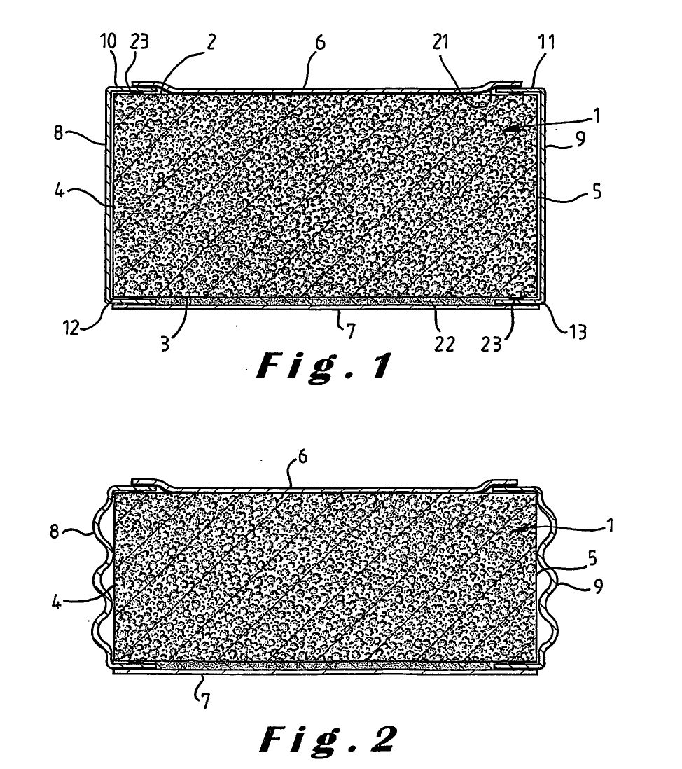

FIGS. 1 and 2 depict a view in transverse section of an insulation product according to the invention, in the expanded state and respectively in the compressed state.

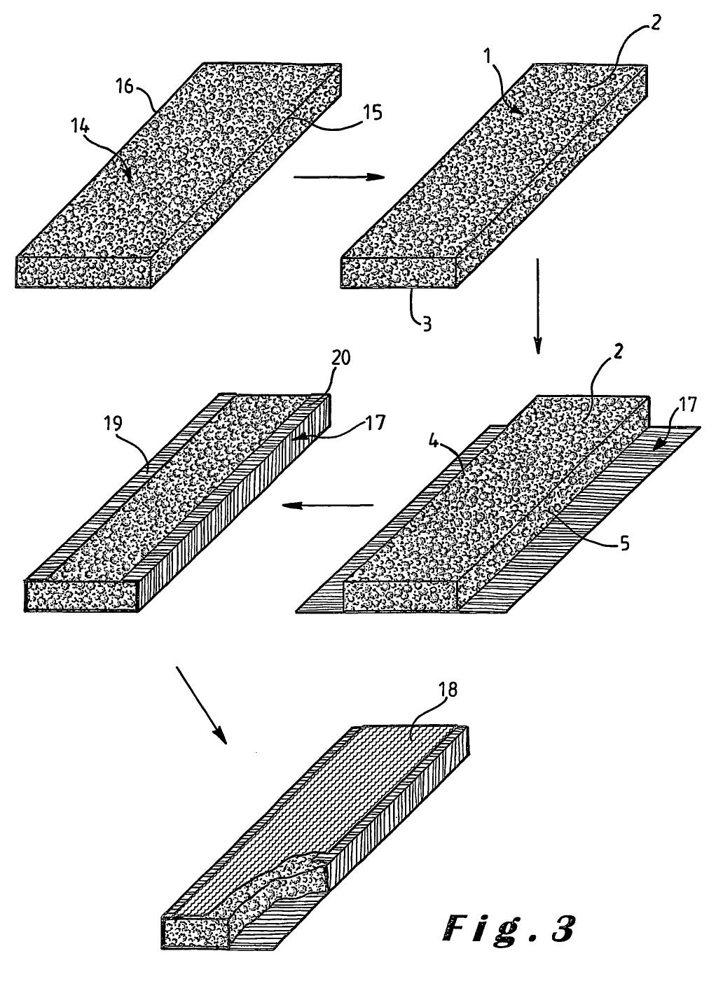

FIGS. 3 to 5 show the steps of three different embodiments of an insulation product according to the invention, depicted in a partially broken form.

In the drawings, the identical or similar elements are designated by the same references. It should be noted that, in these drawings, the proportions of the elements do not correspond to reality and some values have been exaggerated to permit better understanding.

FIG. 1 depicts a view in section of an embodiment of an insulation product, thermal or acoustic, according to the invention.

This product, as illustrated, comprises a mattress 1 of glass fibres or mineral fibres which extends longitudinally. In the view in transverse section it can be seen that this mattress has a first principal surface 2, a second opposite principal surface 3, a first lateral surface 4 and a second opposite lateral surface 5. The product also has two opposite end surfaces, not shown in the drawings.

A cladding covers the two principal surfaces 2 and 3 and the two lateral surfaces 4 and 5.

In the example embodiment illustrated, this cladding comprises a covering strip 6 made from non-woven material, for example polyester, which covers a central part of the first principal surface 2. It does not entirely reach the edges thereof, although this can be envisaged.

The cladding also comprises a covering means formed by three strips, a normal vapour-arresting strip 7 which covers at least a central part and preferably all the second principal surface 3 of the mattress, and two lateral strips 8 and 9 attached to the vapour-arresting strip, on each side thereof. Each lateral ribbon passes in a floating manner along the lateral surfaces 4 and 5 of the mattress, that is to say it is not fixed to these.

As can be seen in FIGS. 1 and 2, the covering band 6 is, in the example embodiment illustrated, connected to the principal surface 2, for example by a layer of hot-melt binder 21 which affords the adhesion of the band 6 to the glass fibre of the mattress 2 and to the folded lateral edges 10 and 11 of the lateral strips 8 and 9.

The vapour-arrester 7 is, in the example embodiment illustrated, a film of aluminised plastics material which is connected to the principal surface 3 and to the lateral edges 12 and 13 of the lateral strips 8 and 9, for example by a layer of glue based on polyvinyl acetate 22.

The edges 10 and 12 and respectively 11 and 13 of the lateral strips are themselves directly connected to the principal surface 2 and respectively to the principal surface 3 by a hot-melt binder 23 for example. As a variant, provision can be made not to directly bond the edges 12 and 13 to the principal surface 3, their connection then being obtained by means of the vapour-arresting strip.

It is obvious that the edges of the lateral strips 4 and 5 can be provided fixed to the principal surface, not in direct contact with the mattress, but also by means of the covering band 6 and/or the vapour-arresting strip 7. These are then interposed between the edges of the lateral strips and the mattress.

As can be seen in FIG. 2, when the mattress is in the compressed state, the lateral strips 8 and 9, by buckling, separate from the mattress 1 and allow the air contained therein to be released easily.

FIG. 3 illustrates a method of manufacturing an insulation product according to the invention in which a vapour arrester is not necessary.

A core 14 of glass fibres is first of all formed, and is next passed through a polymerisation oven which will enable the fibres to be bonded to each other by means of a polymerisable binder with which the fibres were previously treated in a known manner. On emerging, the core 14 is cut along its edges 15 and 16 in order to give, after cutting, a mattress 1 having a predetermined and definitive width.

A glue of the hot-melt type is then applied to the entire principal surface 3 of the mattress and to the longitudinal edges of the principal surface 2. Then a covering band 7 made from a suitable non-woven material is applied and glued to the principal surface 3 of the mattress.

Using suitable means known to persons skilled in the art, the covering band 7 is first of all folded along the opposite lateral surfaces 4 and 5 of the mattress, and then folded over the previously glued edges of the principal surface 2, being thus connected thereto.

In the last step, a covering band 18 made from non-woven material previously coated with an adhesive material, for example of the hot-melt type, is deposited on the principal surface 2 of the mattress whilst covering this and part of the top folded edges 19 and 20 of the covering band 17. In a variant, provision can of course be made for the adhesive material to be first applied to the glass wall of the mattress, instead of the covering band.

A firm connection is thus obtained with the two opposite principal surfaces of the mattress, without connection with the lateral surfaces. The product fabricated has a very advantageous finished appearance. It comprises solely two covering bands for encapsulating the mattress of fibres and can be compressed and expanded without any problem, without risk of delamination between the constituents.

It should be noted that this fabrication advantageously takes place on a line which moves the mattress continuously. The equipment for gluing, moving, transporting or folding the bands or the mattress, as well as the polymerisation oven, are devices well known per se to persons skilled in the art.

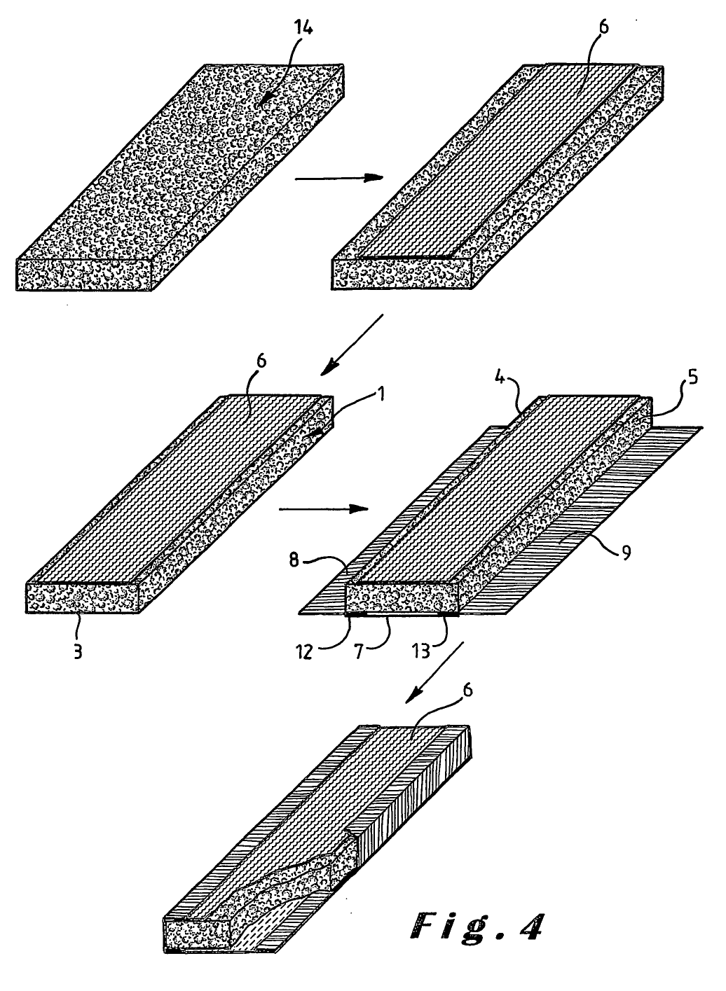

FIG. 4 illustrates a method of manufacturing an advantageous embodiment of an insulation product according to the invention, in which a vapour-arresting strip has been provided.

In this embodiment, the cladding serving for the encapsulation consists of four pieces: a cladding band 6 made from non-woven material, a vapour-arresting strip 7 and two lateral strips 8 and 9 made from non-woven material.

In this example embodiment, the cladding band 6 made from non-woven material, coated with a binder, for example phenolic, is deposited on the fibre core 14, before it passes into the polymerisation oven. The band 6 is thus connected to the core 14 during this passage.

After emerging from the oven, the lateral edges of the core 14 are cut, which gives the mattress 1 of defined thickness.

A vapour-arresting strip 7, normal per se, and to which there are attached on each side, for example by adhesive bonding, lateral strips 8 and 9 made from non-woven material, is applied to the principal surface 3 of the mattress. The vapour-arresting strip is for example a plasticised kraft paper provided on its top face with a foam glue by means of which the paper adheres to the principal surface 3 and to the lateral edges 12 and 13 of the lateral strips 8 and 9.

The lateral strips are then folded along the lateral surfaces 4 and 5 of the mattress, and then folded over this and the marginal parts of the band 7. On the internal face of the edges of the lateral strips or at the edges of the principal surface 2 and 3, the presence of an adhesive has been provided for, for bonding the lateral strips to these surfaces and to the band 7 of non-woven material.

The adhesion of the lateral strips to the principal surfaces or to the band 7 can be obtained by any suitable glue, for example by a polyvinyl acetate, foamed or not, by a hot-melt glue or by a reactivatable glue.

As may be remarked, it is possible, by means of this manufacturing method, to apply a composite encapsulation in which each constituent has an optimum composition according to that for which it serves. In addition, the corners of the product can be reinforced by means of a double thickness of material which improves their mechanical strength. Finally, on the production line, the application stations do not all have to be situated at the same point, which facilitates the operations. A different marking of the constituent parts is also permitted. For example, it is possible to introduce a logo on the covering band 7 and length markings on the lateral strip.

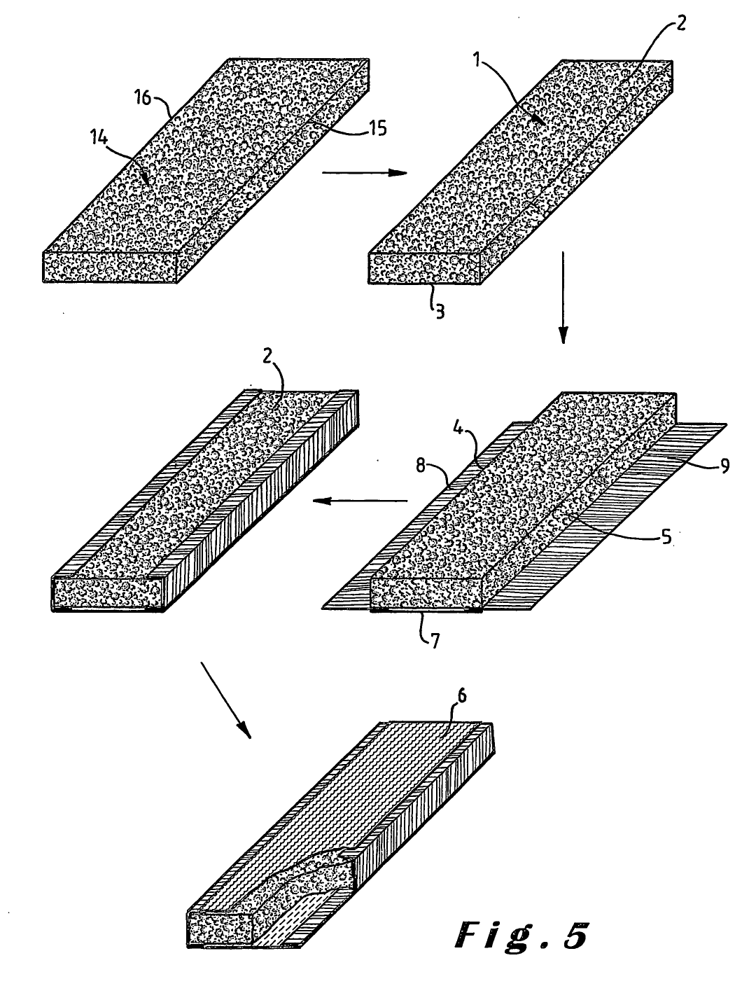

FIG. 5 illustrates a method of manufacturing an embodiment of an insulation product as depicted in FIGS. 1 and 2.

In this example, the core 14 emerges from the polymerisation oven and is immediately cut to the required length in order to form the mattress 1. The two lateral strips 8 and 9 are then moved at the same time as the vapour-arresting strip 7. By application to the principal surface 3, they are, by means of an adhesive layer, connected to the previously glued vapour-arresting strip 7. The strips are then folded along the lateral surfaces 4 and 5 of the mattress, and then folded against the principal surface 2 to which they are connected in the manner already described.

On top of this there is then deposited a covering band 6, which is in its turn glued to the principal surface 2 of the mattress and to the folded edges of the lateral strips.

It must be understood that the present invention is in no way limited to the embodiments described above and that many modifications can be made thereto without departing from the scope of the accompanying claims.

1. Encapsulated insulation product comprising:
a mattress (1) of fibres, which extends longitudinally and comprises first (2) and second (3) opposite principal surfaces, first (4) and second (5) opposite lateral surfaces, and first and second opposite end faces, and
a cladding covering the two principal surfaces and the two lateral surfaces of the mattress,
this cladding comprising a first covering means in the form of a band (6, 18) which covers at least a central part of the first principal surface (2) of the mattress, without extending beyond this first surface and whilst being connected thereto, and a second covering means (7-9; 17) which successively covers the second principal surface (3) of the mattress, its two lateral surfaces (4, 5) and marginal parts of its first principal surface (2),
wherein the second covering means (7-9; 17) is connected to the first and second principal surfaces (2, 3) and floats freely along the opposite lateral surfaces (4, 5) of the mattress (1).

2. Insulation product according to claim 1, wherein the second covering means is a band of non-woven material (17).

3. Insulation product according to claim 1, wherein the second covering means consists of
a central strip (7) which covers at least a central part of the second principal surface (3) of the mattress and which is connected thereto, and
two lateral strips (8, 9) attached to the central strip (7), on each side thereof, each lateral strip passing in a floating manner along a lateral surface (4, 5) of the mattress, and covering at least a marginal part of the first principal surface (2) of the mattress and at least a marginal part of its second principal surface (3) whilst being connected to these.

4. Insulation product according to claim 3, wherein the central strip (7) of the second covering means is a vapour-arresting strip which can cover the whole of the second principal surface (3) of the core.

5. Insulation product according to claim 3, wherein the lateral strips (8, 9) of the second covering means are made from a non-woven material.

6. Insulation product according to claim 3, wherein each lateral strip (8, 9) of the second covering means is in direct abutment on the second principal surface (3) of the mattress whilst, in this position, being partially covered by the central strip (7) of the above-mentioned second covering means.

7. Insulation product according to claim 3, wherein each lateral strip (8, 9) of the second covering means is in direct abutment on the first principal surface (2) of the mattress, whilst, in this position, possibly being covered partially by the first covering means in the form of a band (6, 18).

8. Insulation product according to claim 3, wherein each lateral strip (8, 9) of the second covering means at least partially covers the first covering means in the form of a band (6, 18) connected to the first principal surface (2) of the mattress and wherein it is connected to the first covering means in the form of a band (6, 18).

9. Insulation product according to claim 1, wherein the first covering means in the form of a band (6, 18) is made from a woven or non-woven material.

10. Method of manufacturing an insulation product according to claim 1, comprising:
depositing the first covering in the form of a band on the first principal surface of the mattress of fibres and its connection thereto,
application of the second covering means to the second principal surface of the mattress of fibres and its connection thereto,
folding over the second covering means along the opposite lateral surfaces of the mattress, and
folding the second covering means over at least the marginal parts of the first principal surface with connection of the second covering means to this, so that it floats freely along the opposite lateral surfaces of the mattress.

11. Method according to claim 10, wherein the depositing of the first covering means in the form of a band takes place before the said folding of the second covering means, so that the latter, after folding, at least partially covers the edges of the first covering means in the form of a band, and wherein the method also comprises a connection between the second covering means and the said edges of the first covering means in the form of a band, so that the said connection of the second covering means to the first principal surface takes place by means of the first covering means in the form of a band.

12. Method according to claim 10, wherein the said folding of the second covering means takes place before the said depositing of the first covering means in the form of a band so that it is connected to the first principal surface in direct abutment thereon.

13. Method according to claim 10, wherein the second covering means consists of a central strip and two lateral strips and in that the method also comprises, before or during the application of the second covering means to the second principal surface on the mattress, an attachment of the lateral strips to the central strip, on each side thereof.

14. Method according to claim 10, including a polymerization of a binder by means of which the fibres of the mattress are treated and a cutting of the mattress to size after polymerization.

15. Method according to claim 14, wherein for the said polymerization, it comprises a passage of the mattress of fibres through a polymerization oven, after the said depositing of the first covering means in the form of a band, and wherein the connection of the latter to the first principal surface of the mattress takes place in the oven.

16. Method according to claim 14, wherein the polymerization and the cutting to size take place before the said depositing of the first covering means in the form of a band and the said application in the second covering means.
